(19) United States
(12) Patent Application Publication
(10) Pub. No.: US 2022/0086798 A1
(43) Pub. Date: Mar. 17, 2022

(54) NOTIFICATION MESSAGE PROCESSING METHOD AND TERMINAL

(71) Applicant: VIVO MOBILE COMMUNICATION CO.,LTD, Guangdong (CN)

(72) Inventor: Xuya ZHANG, Guangdong (CN)

(73) Assignee: VIVO MOBILE COMMUNICATION CO.,LTD., Guangdong (CN)

(21) Appl. No.: 17/537,410

(22) Filed: Nov. 29, 2021

Related U.S. Application Data
(63) Continuation of application No. PCT/CN2020/084793, filed on Apr. 14, 2020.

(30) Foreign Application Priority Data
May 30, 2019 (CN) 201910463274.7

(51) Int. Cl. H04W 68/00; H04M 1/72403; G06F 3/04886

(52) U.S. Cl. CPC H04W 68/005; G06F 3/04886; H04M 1/72403

(57) ABSTRACT

A notification message processing method includes: receiving a first input; displaying a first application interface corresponding to a first notification message in a first display area in response to the first input; receiving a second input for the first display area; and switching the first application interface displayed in the first display area to a second application interface corresponding to a second notification message in response to the second input.

### CROSS-REFERENCE TO RELATED APPLICATIONS

The present application is a Bypass Continuation Application of PCT/CN2020/084793 filed on Apr. 14, 2020, which claims priority to Chinese Patent Application No. 201910463274.7 filed on May 30, 2019, which are incorporated herein by reference in their entirety.

### TECHNICAL FIELD

The present disclosure relates to the technical field of communication, and in particular, to a notification message processing method and a terminal.

### BACKGROUND

With the development of the terminal technology, the terminal has more and more applications. In order to provide real-time message service to users, a notification message may be popped up in a notification bar. The terminal may display an application interface corresponding to a first notification message according to a user input of the first notification message in the notification bar, so that the user can view the content of the first notification message. In this way, for each notification message, the user needs to open the notification bar first and then perform click operation on the notification message so as to view the content of the notification message, and the operation process is complicated.

### SUMMARY

The present disclosure provides a notification message processing method and a terminal.

According to a first aspect, embodiments of the present disclosure provide a notification message processing method, applied to a terminal. The method includes:

receiving a first input;

displaying a first application interface corresponding to a first notification message in a first display area in response to the first input;

receiving a second input for the first display area; and

switching the first application interface displayed in the first display area to a second application interface corresponding to a second notification message in response to the second input.

According to a second aspect, embodiments of the present disclosure further provide a terminal, including:

a first receiving module, configured to receive a first input;

a first response module, configured to display a first application interface corresponding to a first notification message in a first display area in response to the first input;

a second receiving module, configured to receive a second input for the first display area; and

a second response module, configured to switch the first application interface displayed by the first display area to a second application interface corresponding to a second notification message.

According to a third aspect, embodiments of the present disclosure further provide a terminal, including a processor, a memory, and a computer program stored in the memory and executable on the processor, wherein when the computer program is executed by the processor, steps of the notification message processing method as described above are implemented.

According to a fourth aspect, embodiments of the present disclosure further provide a non-transitory computer readable storage medium, wherein the non-transitory computer readable storage medium stores a computer program; and when the computer program is executed by a processor, steps of the notification message processing method as described above are implemented.

### BRIEF DESCRIPTION OF THE DRAWINGS

In order to describe the technical solution of the embodiments of the present disclosure more clearly, the accompanying drawings required for describing the embodiments of the present disclosure will be simply introduced below. Obviously, the accompanying drawings described below merely illustrate some embodiments of the present disclosure. Those of ordinary skill in the art may also derive other accompanying drawings from these accompanying drawings.

FIG. 1 is a first flowchart of a notification message processing method according to an embodiment of the present disclosure;

FIG. 2 is a schematic diagram of a notification status bar according to an embodiment of the present disclosure;

FIG. 3 is a second flowchart of a notification message processing method according to an embodiment of the present disclosure;

FIG. 4 is a first schematic diagram of contents displayed by a first display area and a second display area according to an embodiment of the present disclosure;

FIG. 5 is a schematic diagram of a third sub-input according to an embodiment of the present disclosure;

FIG. 6 is a second schematic diagram of contents displayed by a first display area and a second display area according to an embodiment of the present disclosure;

FIG. 7 is a schematic diagram of a first sub-input according to an embodiment of the present disclosure;

FIG. 8 is a third schematic diagram of contents displayed by a first display area and a second display area according to an embodiment of the present disclosure;

FIG. 9 is a schematic diagram of a switching button according to an embodiment of the present disclosure;

FIG. 10 is a fourth schematic diagram of contents displayed by a first display area and a second display area according to an embodiment of the present disclosure;

FIG. 11 is a block diagram of a terminal according to an embodiment of the present disclosure; and

FIG. 12 is a schematic diagram of a hardware structure of a terminal according to an embodiment of the present disclosure.

### DETAILED DESCRIPTION OF EMBODIMENTS

The technical solutions in the embodiments of the present disclosure are described below clearly with reference to the accompanying drawings in the embodiments of the present disclosure. Apparently, the described embodiments are some rather than all of the embodiments of the present disclosure. All other embodiments obtained by a person of ordinary skill in the art based on the embodiments of the present disclosure shall fall within the protection scope of the present disclosure.

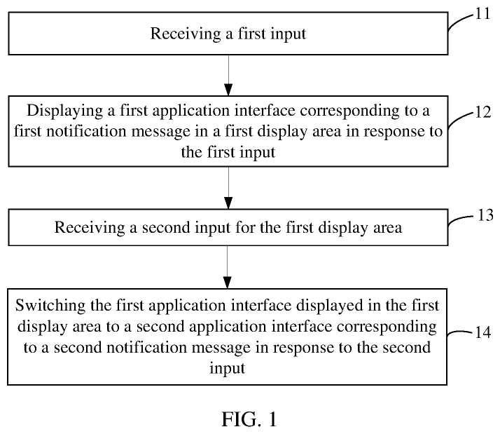

As shown in FIG. 1, the embodiments of the present disclosure provide a notification message processing method, applied to a terminal. The method includes:

Step 11: receiving a first input.

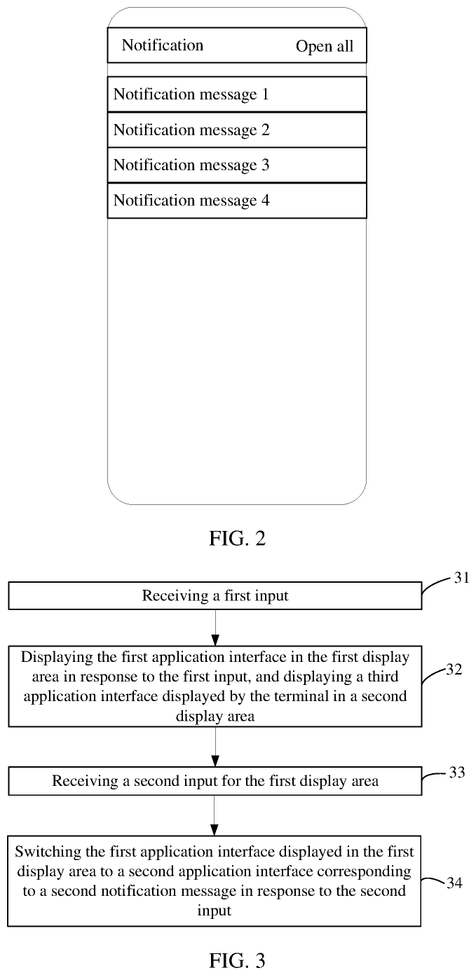

Optionally, the first input may be an input operated by a user on a physical key of the terminal, or may be an input operated by a user on a display screen of the terminal, such as a sliding input of a predetermined sliding track and a clicking input operated by multiple fingers to continuously click on the display screen; in addition, the first input may also be an input operated by a user on one of notification messages in the notification status bar, or an input operated by a user on a virtual key, such as a clicking input operated on an “open all” button in the notification status bar, as shown in FIG. 2.

Step 12: displaying a first application interface corresponding to a first notification message in a first display area in response to the first input.

The first notification message may be one of a plurality of notification messages in the notification status bar, for example, it may be one of the notification messages operated by the first input in the notification status bar; or the first notification message may be the first notification message in the plurality of notification messages in a case that the first input is the clicking input operated by a user on the “open all” button in the notification status bar.

The first display area may be part or all of the area in the display screen of the terminal; or for the terminal with a plurality of display screens, the first display area may also be a display area corresponding to one of the display screens of the terminal.

Step 13: receiving a second input for the first display area.

Optionally, the second input may be an input operated by a user on the display of the terminal, such as a sliding input of a predetermined sliding track, a clicking input operated by multiple fingers to continuously click on the display screen and a multi-finger sliding input operated on the display screen.

Step 14: switching the first application interface displayed in the first display area to a second application interface corresponding to a second notification message in response to the second input.

The first notification message is: one of a plurality of notification messages arranged in according to an order; and the second notification message is: one notification message, arranged adjacent to the first notification message, of the plurality of notification messages. That is, the second notification message is: the first notification message, arranged after the first notification message, of the plurality of notification messages, or the last notification message, arranged before the first notification message, of the plurality of notification messages.

For example, the first notification message is “notification message 1” in FIG. 2, and the second notification message is “notification message 2” in FIG. 2; optionally, in a case that the first display area displays an application interface corresponding to the “notification message 2” currently, a second input for the first display area is received, and the application interface corresponding to the “notification message 2” displayed by the first display area to an application interface corresponding to “notification message 3” in response to the second input, and when there are more notification messages in the notification status bar, it may be analogized according to this method, which will thus not be elaborated herein.

As an implementation manner, the step 13 may include: receiving a first sub-input for the first display area, wherein the first sub-input is a sliding input in a first direction, such as a multi-finger sliding input.

The step 14 may include: deleting the first notification message in response to the first sub-input and displaying the second application interface in the first display area.

Optionally, the first sub-input may be a sliding input of three-finger transverse (a width direction of the display screen) sliding on the first display area which displays the first application interface, the first notification message may be deleted from the notification status bar, and the next notification message of the deleted notification message is displayed in the first display area.

For example, when the first display area displays the application interface corresponding to the “notification message 1” in FIG. 2 currently, if the first sub-input for the first display area is received, the “notification message 1” in the notification status bar in FIG. 2 is deleted, and the application interface corresponding to the “notification message 2” is switched to be displayed in the first display area.

When the first display area displays the application interface corresponding to the “notification message 2” in FIG. 2 currently, if the first sub-input for the first display area is received, the “notification message 2” in the notification status bar in FIG. 2 is deleted, and the application interface corresponding to “notification message 3” is switched to be displayed in the first display area; and when there are a plurality of notification messages in the notification status bar, it may be analogized according to this method, which will thus not be elaborated herein.

As another implementation manner, the second input is a second sub-input for a switching button in the first display area. That is, the step 13 may include: receiving the second sub-input for the first display area, wherein the second sub-input is an input for the switching button in the first display area.

The step 14 may include: in response to the second sub-input, displaying the second application interface in the first display area without deleting the first notification message.

Optionally, a switching button may be displayed in the first display area through the first input in a case that the display area displays the first application interface corresponding to the first notification message (for example: a button for switching to the previous notification message, or a button for switching to the next notification message). Optionally, the switching button may be displayed in a suspending manner.

The previous notification message of the notification message corresponding to the first application interface may be displayed in the first display area through the input for the button for switching to the previous notification message; and the next notification message of the notification message corresponding to the first application interface may be displayed in the first display area through the input for the button for switching to the next notification message.

For example: when the application interface corresponding to the “notification message 1” in FIG. 2 is displayed in the first display area currently, if the input for the button for switching to the previous notification message is received, an application interface corresponding to “notification message 4” in the notification status bar in FIG. 2 is displayed in the first display area; if the input for the button for switching to the next notification message is received, the application interface corresponding to the “notification message 2” in the notification status bar in FIG. 2 is displayed in the first display area.

When the first display area displays the application interface corresponding to the “notification message 2” in FIG. 2 currently, if the input for the button for switching to the previous notification message is received, the application interface corresponding to the “notification message 1” in the notification status bar in FIG. 2 is displayed in the first display area; if the input for the button for switching to the next notification message is received, the application interface corresponding to the “notification message 3” in the notification status bar in FIG. 2 is displayed in the first display area; and when there are a plurality of notification messages in the notification status bar, it may be analogized according to this method, which will thus not be elaborated herein. Furthermore, all the notification messages in the notification status bar are traversed in this way, and it may be switched to the first application interface.

In the above solution, in a case that the first application interface corresponding to the first notification message is displayed in the first display area through the first input, the first application interface displayed by the first display area may be switched to a second application interface corresponding to a second notification message through a second input for the first display area. In this way, a user may realize the display switching of the content of the notification message directly through the operation for the first display area and realize rapid view of the notification message, thereby being beneficial to simplify the operation and avoiding the complicated process that it is necessary to open the notification bar and then perform click operation for the notification message to view the content of the notification message.

As shown in FIG. 3, the embodiments of the present disclosure further provide a notification message processing method, applied to a terminal. The method includes:

Step 31: receiving a first input.

Step 32: displaying the first application interface in the first display area in response to the first input, and displaying in a second display area, a third application interface displayed by the terminal.

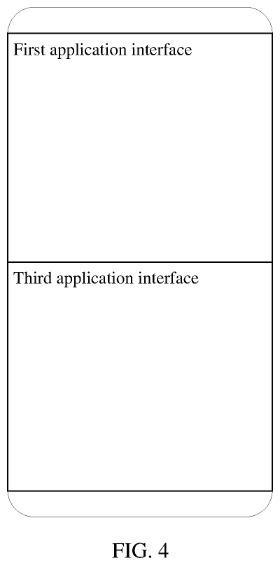

Optionally, in a case that the terminal displays the third application interface currently, if the first input is received, split screen display processing is executed in response to the first input, that is, when the first display area displays the first application interface, the third application interface displayed by the terminal is displayed in the second display area, as shown in FIG. 4.

This embodiment may ensure that the first application interface corresponding to the first notification message can be displayed while the third application interface is in foreground processing, thereby avoiding the influence on the operation of the current application in the terminal by viewing the first notification message.

In particular, for the terminal with a first screen and at least one second screen, the notification messages in the notification status bar are opened one by one, and the application interfaces corresponding to the notification messages are displayed on the first display respectively in a split screen display manner. If the display area in the first screen is not enough to display the application interfaces corresponding to these notification messages, the application interfaces corresponding to the notification messages which cannot be displayed may be displayed on the second screen. For example: the application interface corresponding to the notification message of the second screen may be switched to the first display for display through the multi-finger sliding input on the first screen or the input on the switching button; in addition, a user may also read the contents displayed in the first screen and the second screen respectively by directly overturning the terminal.

Step 33: receiving a second input for the first display area.

Step 34: switching the first application interface displayed in the first display area to a second application interface corresponding to a second notification message in response to the second input.

As an implementation manner, the step 33 may include: receiving a third sub-input for the first display area, wherein the third sub-input is a sliding input in a second direction, such as a multi-finger sliding input.

The step 34 may include: displaying a content currently displayed in the first display area in the second display area in response to the third sub-input, and displaying the second application interface in the first display area.

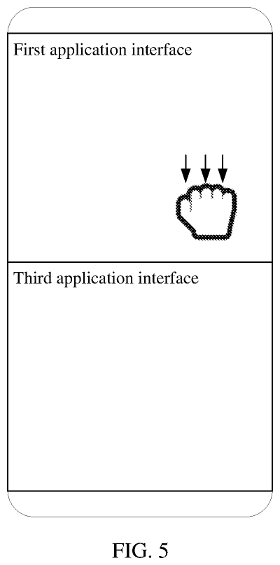

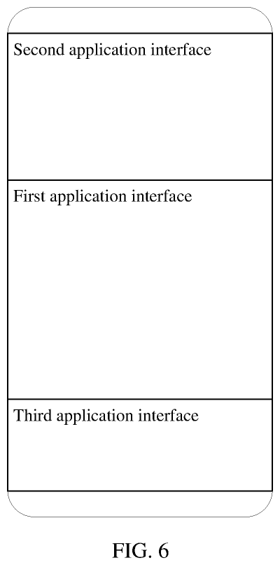

Optionally, the third sub-input may be a sliding input of three-finger longitudinal (a length direction of the display screen) sliding on the first display area which displays the first application interface (as shown in the arrowhead in FIG. 5, certainly, it may be a sliding input of upward sliding), the first application interface displayed in the first display area may be switched to the second application interface, and the third application interface displayed in the second display area may be switched to the first application interface. In particular, the contents displayed in the first display area and the second display area may be switched in a rolling switching manner according to the sliding direction of the sliding input, as shown in FIG. 6.

For example: when the first display area displays the application interface corresponding to the “notification message 1” in FIG. 2 currently and the second display area displays the third application interface, if the third sub-input for the first display area is received, the application interface corresponding to the “notification message 4” in the notification status bar in FIG. 2 is displayed in the first display area, and the first application interface is displayed in the first display area.

Currently the first display area displays the application interface corresponding to the “notification message 2” in FIG. 2, and the second display area displays the third application interface. If the third sub-input for the first display area is received, the application interface corresponding to the “notification message 1” in the notification status bar in FIG. 2 is displayed in the first display area, and the application interface corresponding to the “notification message 2” in FIG. 2 is displayed in the second display area. When there are a plurality of notification messages in the notification status bar, it may be analogized according to this method, which will thus not be elaborated herein.

In this embodiment, when a user needs to display applications corresponding to at least two notification messages at the same time, the user may slide up and down longitudinally on the display screen without multiple fingers, the first display are and the second display area may sequentially display the notification messages in the notification status bar in a split screen manner; furthermore, for communication and social applications, an operable replay interface is provided when the corresponding notification messages are displayed.

When the third application interface displayed in the second display area is switched to the application interface corresponding to the notification message, the third application interface runs in the background; and when the first application interface is slid to the first display area or the second display area again, the third application interface is restored to the foreground use status.

As another an implementation manner, the step 33 may include: receiving a first sub-input for the first display area, wherein the first sub-input is a sliding input in a first direction, such as a multi-finger sliding input.

The step 34 may include: deleting the first notification message in response to the first sub-input and displaying the second application interface in the first display area, wherein the second display area maintains the display of the third application interface.

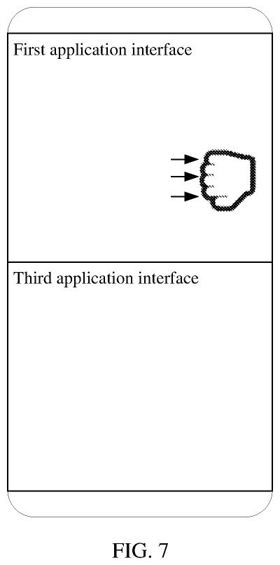

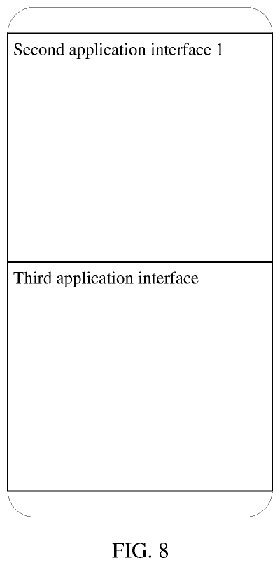

Optionally, the first sub-input may be a sliding input of three-finger transverse (a width direction of the display screen) sliding on the first display area which displays the first application interface (as shown in the arrowhead in FIG. 7), the first notification message may be deleted from the notification status bar, the next notification message of the deleted notification message is displayed in the first display area, and the second display area maintains the display of the third application interface (as shown in FIG. 8).

For example, when the first display area displays the application interface corresponding to the “notification message 1” in FIG. 2 currently, if the first sub-input for the first display area is received, the “notification message 1” in the notification status bar in FIG. 2 is deleted, the application interface corresponding to the “notification message 2” is switched to be displayed in the first display area, and the second display area maintains the display of the third application interface.

When the first display area displays the application interface corresponding to the “notification message 2” in FIG. 2 currently, if the first sub-input for the first display area is received, the “notification message 2” in the notification status bar in FIG. 2 is deleted, the application interface corresponding to “notification message 3” is switched to be displayed in the first display area, and the second display area maintains the display of the third application interface; and when there are a plurality of notification messages in the notification status bar, it may be analogized according to this method, which will thus not be elaborated herein.

As yet another implementation manner, the second input is a second sub-input for a switching button in the first display area. That is, the step 33 may include: receiving the second sub-input for the first display area, wherein the second sub-input is an input for the switching button in the first display area.

The step 34 may include: in response to the second sub-input, displaying the second application interface in the first display area without deleting the first notification message, and the second display area maintains the display of the third application interface.

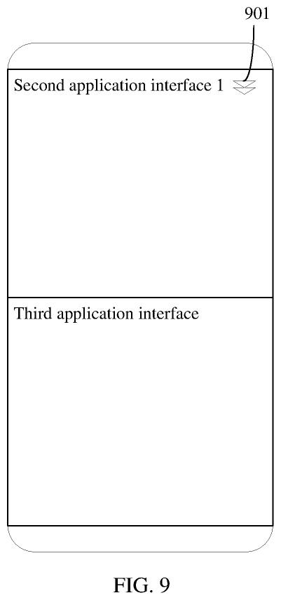

Optionally, a switching button may be displayed in the first display area through the first input in a case that the display area displays the first application interface corresponding to the first notification message (for example: a button for switching to the previous notification message, or a button 901 for switching to the next notification message in FIG. 9). Optionally, the switching button may be displayed in a suspending manner.

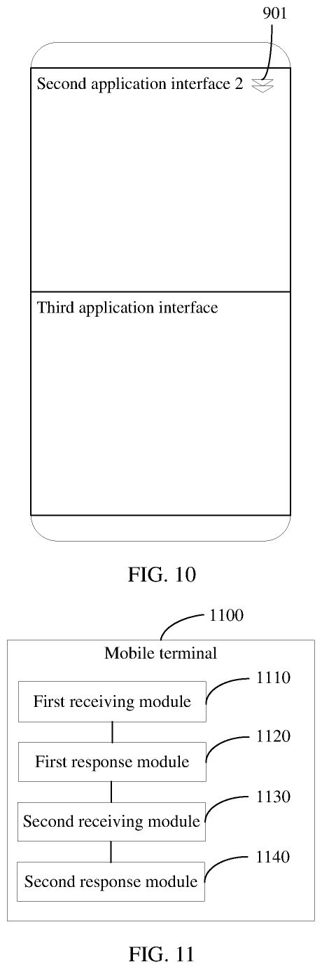

The previous notification message of the notification message corresponding to the first application interface may be displayed in the first display area through the input for the button for switching to the previous notification message, and the second display area maintains the display of the third application interface; and the next notification message of the notification message corresponding to the first application interface may be displayed in the first display area through the input for the button for switching to the next notification message, and the second display area maintains the display of the third application interface, as shown in FIG. 10.

For example: the first display area displays the application interface corresponding to the “notification message 1” in FIG. 2 currently, if the input for the button for switching to the previous notification message is received, the application interface corresponding to the “notification message 4” in the notification status bar in FIG. 2 is displayed in the first display area, and the second display area maintains the display of the third application interface; if the input for the button for switching to the next notification message is received, the application interface corresponding to the “notification message 2” in the notification status bar in FIG. 2 is displayed in the first display area, and the second display area maintains the display of the third application interface.

The first display area displays the application interface corresponding to the “notification message 2” in FIG. 2 currently, if the input for the button for switching to the previous notification message is received, the application interface corresponding to the “notification message 1” in the notification status bar in FIG. 2 is displayed in the first display area, and the second display area maintains the display of the third application interface; if the input for the button for switching to the next notification message is received, the application interface corresponding to the “notification message 3” in the notification status bar in FIG. 2 is displayed in the first display area, and the second display area maintains the display of the third application interface; and when there are a plurality of notification messages in the notification status bar, it may be analogized according to this method, which will thus not be elaborated herein. Furthermore, all the notification messages in the notification status bar are traversed in this way, and it may be switched to the first application interface.

In the above solution, the notification that the second area displays the third application interface through the first input may display the first application interface corresponding to the first notification message in the first display area, which may ensure that the first application interface corresponding to the first notification message can be displayed while the third application interface is in foreground processing, thereby avoiding the influence on the operation of the current application in the terminal by viewing the first notification message. Optionally, the first application interface displayed in the first display area may also be switched to the second application interface corresponding to the second notification message through the second input for the first display area. In this way, a user may realize the display switching of the content of the notification message directly through the operation for the first display area and realize rapid view of the notification message, thereby being beneficial to simplify the operation and avoiding the complicated process that it is necessary to open the notification bar and then perform click operation for the notification message to view the content of the notification message.

As shown in FIG. 11, the embodiments of the present disclosure further provide a terminal 1100, including:

a first receiving module 1110, configured to receive a first input;

a first response module 1120, configured to display a first application interface corresponding to a first notification message in a first display area in response to the first input;

a second receiving module 1130, configured to receive a second input for the first display area; and

a second response module 1140, configured to switch the first application interface displayed by the first display area to a second application interface corresponding to a second notification message.

Optionally, the first notification message is: one of a plurality of notification messages arranged according to an order; and

the second notification message is: one notification message, arranged adjacent to the first notification message, of the plurality of notification messages.

Optionally, the second receiving module 1130 includes:

a first receiving unit, configured to receive a first sub-input for the first display area, the first sub-input being a sliding input in a first direction; and

the second response module 1140 includes:

a first response unit, configured to delete the first notification message in response to the first sub-input and display the second application interface in the first display area.

Optionally, the second input is a second sub-input for a switching button in the first display area.

Optionally, the first response module 1120 includes:

a display unit, configured to display the first application interface in the first display area, and display in a second display area, a third application interface displayed by the terminal.

Optionally, the second receiving module 1130 includes:

a second receiving unit, configured to receive a third sub-input for the first display area, the third sub-input being a sliding input in a second direction; and

the second response module 1140 includes:

a second response unit, configured to display a content currently displayed in the first display area in the second display area in response to the third sub-input, and display the second application interface in the first display area.

The terminal provided by the embodiment of the present disclosure can implement processes implemented by the terminal in the method embodiments of FIG. 1 to FIG. 10. To avoid repetition, details are not described herein again.

The terminal 1100 in the embodiments of the present disclosure may switch the first application interface displayed in the first display area to the second application interface corresponding to the second notification message through the second input for the first display area in a case that the first display area displays the first application interface corresponding to the first notification message through the first input. In this way, a user may realize the display switching of the content of the notification message directly through the operation for the first display area and realize rapid view of the notification message, thereby being beneficial to simplify the operation and avoiding the complicated process that it is necessary to open the notification bar and then perform click operation for the notification message to view the content of the notification message.

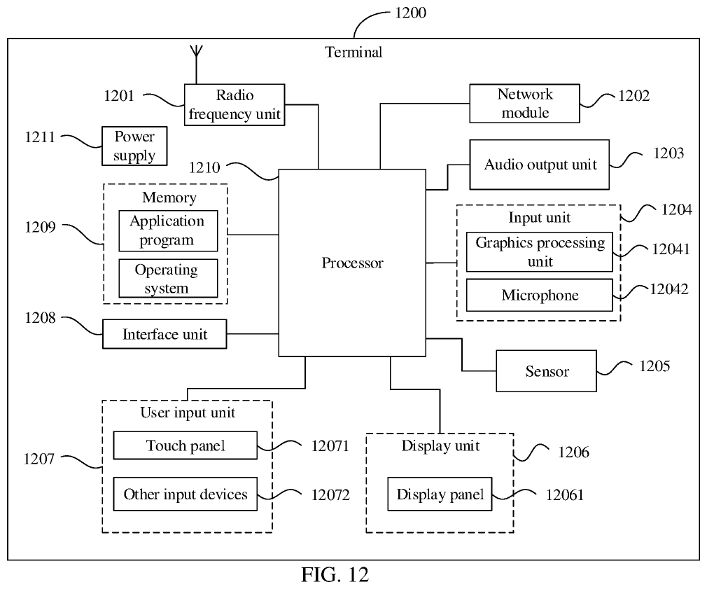

FIG. 12 is a schematic diagram of a hardware structure of a terminal according to embodiments of the present disclosure.

The terminal 1200 includes, but is not limited to: a radio frequency unit 1201, a network module 1202, an audio output unit 1203, an input unit 1204, a sensor 1205, a display unit 1206, a user input unit 1207, an interface unit 1208, a memory 1209, a processor 1210 and a power supply 1211. Those skilled in the art may understand that the terminal structure shown in FIG. 12 does not constitute a limitation on the terminal. The terminal may include more or fewer components than those shown in the figure, or some components may be combined, or there may be a different component arrangement. In this embodiment of the present disclosure, the terminal includes but is not limited to a mobile phone, a tablet computer, a notebook computer, a palmtop computer, a vehicle-mounted terminal, a wearable device, a pedometer, or the like.

The user input unit 1207 is configured to receive a first input;

the processor 1210 is configured to display a first application interface corresponding to a first notification message in a first display area in response to the first input;

the user input unit 1207 is further configured to receive a second input for the first display area; and

the processor 1210 is further configured to switch the first application interface displayed in the first display area to a second application interface corresponding to a second notification message in response to the second input.

The terminal 1200 in the embodiments of the present disclosure may switch the first application interface displayed in the first display area to the second application interface corresponding to the second notification message through the second input for the first display area in a case that the first display area displays the first application interface corresponding to the first notification message through the first input. In this way, a user may realize the display switching of the content of the notification message directly through the operation for the first display area and realize rapid view of the notification message, thereby being beneficial to simplify the operation and avoiding the complicated process that it is necessary to open the notification bar and then perform click operation for the notification message to view the content of the notification message.

It should be understood that, in this embodiment of the present disclosure, the radio frequency unit 1201 may be configured to receive and send information or a signal in a call process. For example, after receiving downlink data from a base station, the radio frequency unit 1201 sends the downlink data to the processor 1210 for processing. In addition, the radio frequency unit 1201 sends uplink data to the base station. Usually, the radio frequency unit 1201 includes, but not limited to, an antenna, at least one amplifier, a transceiver, a coupler, a low noise amplifier, and a duplexer. In addition, the radio frequency unit 1201 may communicate with a network and other devices by using a wireless communication system.

The terminal provides a user with wireless broadband Internet access by using the network module 1202, for example, helping the user send and receive emails, browse web pages, and access streaming media.

The audio output unit 1203 may convert audio data received by the radio frequency unit 1201 or the network module 1202 or stored in the memory 1209 into an audio signal and output the audio signal as a sound. Moreover, the audio output unit 1203 may further provide audio output (for example, call signal receiving sound and message receiving sound) related to a specific function performed by the terminal 1200. The audio output unit 1203 includes a speaker, a buzzer, a receiver, and the like.

The input unit 1204 is configured to receive audio or video signals. The input unit 1204 may include a graphics processing unit (GPU) 12041 and a microphone 12042. The graphics processing unit 12041 processes image data of a static picture or a video obtained by an image capture apparatus (such as a camera) in a video capture mode or an image capture mode. A processed image frame may be displayed on the display unit 1206. The image frame processed by the graphics processor 12041 may be stored in the memory 1209 (or another storage medium) or transmitted by using the radio frequency unit 1201 or the network module 1202. The microphone 12042 may receive a sound and can process such sound into audio data. The processed audio data may be converted, in a call mode, into a format that may be transmitted to a mobile communication base station by using the radio frequency unit 1201 for output.

The terminal 1200 further includes at least one sensor 1205, for example, a light sensor, a motion sensor, and another sensor. The light sensor includes an ambient light sensor and a proximity sensor. The ambient light sensor may adjust luminance of the display panel 12061 based on brightness of ambient light. The proximity sensor may turn off the display panel 12061 and/or backlight when the terminal 1200 moves to an ear. As a type of motion sensor, the acceleration sensor can detect a value of an acceleration in each direction (generally three axes), and detect a value and a direction of gravity when the acceleration sensor is static, and may be configured to recognize a terminal posture (for example, switching between a landscape screen and a portrait screen, relevant games, and magnetometer posture calibration) and perform a function related to vibration recognition (such as a pedometer or a knock), and the like. The sensor 1205 may further include a fingerprint sensor, a pressure sensor, an iris sensor, a molecular sensor, a gyroscope, a barometer, a hygrometer, a thermometer, an infrared sensor, and the like. Details are not described herein.

The display unit 1206 is configured to display information entered by a user or information provided for a user. The display unit 1206 may include a display panel 12061, and the display panel 12061 may be configured in a form of a liquid crystal display (LCD), an organic light-emitting diode (OLED), or the like.

A user input unit 1207 may be configured to receive input digital or character information, and generate key signal input related to user setting and function control of a terminal. The user input unit 1207 includes a touch panel 12071 and another input device 12072. The touch panel 12071, also called a touch screen, may collect touch operation on or near the touch panel by users (for example, operation on the touch panel 12071 or near the touch panel 12071 by fingers or any suitable objects or accessories such as a touch pen by the users). The touch panel 12071 may include two parts: a touch detection device and a touch controller. The touch detection device detects a touch position of a user, detects a signal brought by a touch operation, and transmits the signal to the touch controller. The touch controller receives touch information from the touch detection apparatus, converts the touch information into contact coordinates, sends the contact coordinates to the processor 1210, and receives and executes a command from the processor 1210. In addition, the touch panel 12071 may be implemented by various types such as a resistive type, a capacitive type, an infrared ray type or a surface acoustic wave type. In addition to the touch panel 12071, the user input unit 1207 may further include other input devices 12072. The other input devices 12072 may include but are not limited to a physical keyboard, function keys (such as a volume control key and an on/off key), a trackball, a mouse, and a joystick. Details are not described herein.

Optionally, the touch panel 12071 may cover the display panel 12061. When detecting the touch operation on or near the touch panel 12071, the touch panel 12071 transmits the touch operation to the processor 1210 to determine a type of a touch event, and then the processor 1210 provides corresponding visual output on the display panel 12061 based on the type of the touch event. In FIG. 12, the touch panel 12071 and the display panel 12061 are used as two independent components to implement input and output functions of the terminal. However, in some embodiments, the touch panel 12071 and the display panel 12061 may be integrated to implement the input and output functions of the terminal. This is not specifically limited herein.

The interface unit 1208 is an interface connecting an external device to the terminal 1200. For example, the external apparatus may include a wired or wireless headset port, an external power supply (or a battery charger) port, a wired or wireless data port, a memory card port, a port for connecting an apparatus having an identification module, an audio input/output (I/O) port, a video I/O port, a headset port, and the like. The interface unit 1208 may be configured to receive an input (for example, data information and power) from an external apparatus and transmit the received input to one or more elements within the terminal 1200, or may be configured to transmit data between the terminal 1200 and the external apparatus.

The memory 1209 may be configured to store a software program and various data. The memory 1209 may mainly include a program storage area and a data storage area. The program storage area may store an operating system, an application required by at least one function (for example, an audio playing function and an image playing function), and the like. The data storage area may store data (for example, audio data and an address book) created according to use of the mobile phone. In addition, the memory 1209 may include a high speed random access memory, and may further include a non-volatile memory, for example, at least one magnetic disk memory device, a flash memory device, or other non-volatile solid state memory devices.

The processor 1210 is a control center of the terminal, and is connected to all the parts of the entire terminal by using various interfaces and lines. It performs various functions of the terminal and processes data by running or executing the software programs and/or modules stored in the memory 1209 and by invoking data stored in the memory 1209, it performs overall monitoring of the terminal. The processor 1210 may include one or more processing units. Optionally, an application processor and a modem processor may be integrated into the processor 1210. The application processor mainly processes an operating system, a user interface, an application, and the like. The modem processor mainly processes wireless communication. It may be understood that, alternatively, the modem processor may not be integrated into the processor 1210.

The terminal 1200 may further include a power supply 1211 (for example, a battery) that supplies power to various components. Optionally, the power supply 1211 may be logically connected to the processor 1210 through a power supply management system, to perform functions of managing charging, discharging, and power consumption through the power supply management system.

In addition, the terminal 1200 includes some function modules not shown, and details are not described herein.

Optionally, the embodiments of the present disclosure further provides a terminal, including a processor 1210, a memory 1209, and a computer program stored in the memory 1209 and executable on the processor 1210, wherein when the computer program is executed by the processor 1210, various processes of the embodiment of the foregoing notification message processing method are implemented and a same technical effect can be achieved. To avoid repetition, details are not described herein again.

The embodiments of the present disclosure further provide a non-transitory computer readable storage medium. A computer program is stored in the non-transitory computer readable storage medium. When the computer program is executed by a processor, various processes of the embodiment of the foregoing notification message processing method are implemented, and a same technical effect can be achieved. To avoid repetition, details are not described herein. The non-transitory computer readable storage medium includes a read-only memory (ROM), a random-access memory (RAM), a magnetic disk, an optical disc, or the like.

It should be noted that, in this specification, the terms “include”, “comprise”, or any of their variants are intended to cover a non-exclusive inclusion, such that a process, a method, an article, or an apparatus that includes a list of elements not only includes those elements, but also includes other elements that are not expressly listed, or further includes elements inherent to such a process, method, article, or apparatus. An element limited by “includes a . . . ” does not, without more constraints, preclude the presence of additional identical elements in the process, method, article, or device that includes the element.

Based on the foregoing descriptions of the embodiments, a person skilled in the art may clearly understand that the method in the foregoing embodiment may be implemented by software in addition to a necessary universal hardware platform or by hardware only. In most circumstances, the former is a preferred implementation manner. Based on such an understanding, the technical solutions of the present disclosure essentially or the part contributing to the prior art may be implemented in a form of a software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of the present disclosure.

The embodiments of the present disclosure are described above with reference to the accompanying drawings, but the present disclosure is not limited to the foregoing specific implementations. The foregoing specific implementations are merely exemplary instead of restrictive. Under enlightenment of the present disclosure, a person of ordinary skills in the art may make many forms without departing from the aims of the present disclosure and the protection scope of claims, all of which fall within the protection of the present disclosure.

What is claimed is:

1. A notification message processing method, applied to a terminal and comprising:
receiving a first input;
displaying a first application interface corresponding to a first notification message in a first display area in response to the first input;
receiving a second input for the first display area; and
switching the first application interface displayed in the first display area to a second application interface corresponding to a second notification message in response to the second input.

2. The notification message processing method according to claim 1, wherein the first notification message is: one of a plurality of notification messages arranged according to an order; and
the second notification message is: one notification message, arranged adjacent to the first notification message, of the plurality of notification messages.

3. The notification message processing method according to claim 1, wherein the receiving the second input for the first display area comprises:
receiving a first sub-input for the first display area, the first sub-input being a sliding input in a first direction; and
the switching the first application interface displayed in the first display area to the second application interface corresponding to the second notification message in response to the second input comprises:
in response to the first sub-input, deleting the first notification message, and displaying the second application interface in the first display area.

4. The notification message processing method according to claim 1, wherein the displaying the first application interface corresponding to the first notification message in the first display area comprises:
displaying the first application interface in the first display area, and displaying in a second display area, a third application interface displayed by the terminal.

5. The notification message processing method according to claim 4, wherein the receiving the second input for the first display area comprises:
receiving a third sub-input for the first display area, the third sub-input being a sliding input in a second direction; and
the switching the first application interface displayed in the first display area to the second application interface corresponding to the second notification message in response to the second input comprises:
in response to the third sub-input, displaying a content currently displayed in the first display area in the second display area, and displaying the second application interface in the first display area.

6. A terminal, comprising a processor, a memory, and a computer program stored in the memory and executable on the processor, wherein the computer program, when executed by the processor, causes the terminal to perform:
receiving a first input;
displaying a first application interface corresponding to a first notification message in a first display area in response to the first input;
receiving a second input for the first display area; and
switching the first application interface displayed in the first display area to a second application interface corresponding to a second notification message in response to the second input.

7. The terminal according to claim 6, wherein the first notification message is: one of a plurality of notification messages arranged according to an order; and
the second notification message is: one notification message, arranged adjacent to the first notification message, of the plurality of notification messages.

8. The terminal according to claim 6, wherein the computer program, when executed by the processor, causes the terminal to perform:
receiving a first sub-input for the first display area, the first sub-input being a sliding input in a first direction; and
in response to the first sub-input, deleting the first notification message, and displaying the second application interface in the first display area.

9. The terminal according to claim 6, wherein the computer program, when executed by the processor, causes the terminal to perform:
displaying the first application interface in the first display area, and displaying in a second display area, a third application interface displayed by the terminal.

10. The terminal according to claim 9, wherein the computer program, when executed by the processor, causes the terminal to perform:
receiving a third sub-input for the first display area, the third sub-input being a sliding input in a second direction; and
in response to the third sub-input, displaying a content currently displayed in the first display area in the second display area, and displaying the second application interface in the first display area.

11. A non-transitory computer readable storage medium, storing a computer program, wherein the computer program, when executed by a processor of a terminal, causes the terminal to perform:
receiving a first input;
displaying a first application interface corresponding to a first notification message in a first display area in response to the first input;
receiving a second input for the first display area; and
switching the first application interface displayed in the first display area to a second application interface corresponding to a second notification message in response to the second input.

12. The non-transitory computer readable storage medium according to claim 11, wherein the first notification message is: one of a plurality of notification messages arranged according to an order; and
the second notification message is: one notification message, arranged adjacent to the first notification message, of the plurality of notification messages.

13. The non-transitory computer readable storage medium according to claim 11, wherein the computer program, when executed by the processor, causes the terminal to perform:
receiving a first sub-input for the first display area, the first sub-input being a sliding input in a first direction; and
in response to the first sub-input, deleting the first notification message, and displaying the second application interface in the first display area.

14. The non-transitory computer readable storage medium according to claim 11, wherein the computer program, when executed by the processor, causes the terminal to perform:
displaying the first application interface in the first display area, and displaying in a second display area, a third application interface displayed by the terminal.

15. The non-transitory computer readable storage medium according to claim 14, wherein the computer program, when executed by the processor, causes the terminal to perform:
receiving a third sub-input for the first display area, the third sub-input being a sliding input in a second direction; and
in response to the third sub-input, displaying a content currently displayed in the first display area in the second display area, and displaying the second application interface in the first display area.
